(19) United States
(12) Patent Application Publication
(10) Pub. No.: US 2022/0058555 A1
(43) Pub. Date: Feb. 24, 2022

(54) INFORMATION PROCESSING APPARATUS, PRODUCTION PLAN DETERMINATION METHOD, AND NON-TRANSITORY COMPUTER READABLE MEDIUM STORING PROGRAM

(71) Applicant: NEC Corporation, Minato-ku, Tokyo (JP)

(72) Inventors: Akihiro YABE, Tokyo (JP); Katsuya TONO, Tokyo (JP)

(73) Assignee: NEC Corporation, Minato-ku, Tokyo (JP)

(21) Appl. No.: 17/275,374

(22) PCT Filed: Sep. 14, 2018
(86) PCT No.: PCT/JP2018/034139

§ 371 Date: Mar. 11, 2021

(51) Int. Cl. G06Q 10/06; G06Q 50/06

(52) U.S. Cl. CPC G06Q 10/06315; G06Q 50/06

(57) ABSTRACT

An information processing (1) includes: input means (2) for inputting a predicted value of an amount of demand at each of a plurality of times; and output means (3) for outputting a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

### TECHNICAL FIELD

The present disclosure relates to an information processing apparatus, a production plan determination method, and a non-transitory computer readable medium storing a program.

### BACKGROUND ART

In recent years, an information processing apparatus or an information processing system that provides optimum information under a predetermined condition to a user based on a large amount of information has been used. For example, in the control of a power generation system including a plurality of generators, an electric power utility company needs to obtain a power generation plan in which the amount of power generated by each generator which satisfies a predetermined condition (e.g., a condition in which the production costs are minimized while satisfying total demand power) is determined. Therefore, the electric power utility company creates, for example, an optimization model obtained by modeling a power generation system based on a demand forecast (a forecast of a total demand power). Further, in order to determine an optimum amount of generated power (an optimum solution), the electric power utility company calculates the optimum solution (the amount of generated power) of the optimization model.

Here, referring to a power generation plan as an example, a power demand includes uncertainty because it is determined based on a plurality of factors such as temperature, weather, a forecast error, and the like. That is, the power demand includes an uncertain constraint. In the following description, an uncertain constraint is referred to as a range of uncertainty. Further, the range of values that can be taken as the amount of power generated by each generator is determined based on the amount of power generated at the immediately previous time, and the amount of generated power cannot be extremely reduced or increased. That is, there is a constraint that the amount of power generated by each generator cannot be changed suddenly. A technique for determining an optimum solution (an optimum power generation plan) of an optimization model when there is uncertainty in the amount of demand such as a power demand and a constraint is set in the amount of production such as the amount of power generated by each generator as described above has been studied.

Examples of techniques related to the above technique include the technique disclosed in Patent Literature 1. Patent Literature 1 discloses an operation plan formulation apparatus that calculates operation plans of a plurality of generators.

### CITATION LIST

### Patent Literature

Patent Literature 1: Japanese Unexamined Patent Application Publication No. 2016-063609

### SUMMARY OF INVENTION

### Technical Problem

The operation plan formulation apparatus disclosed in Patent Literature 1 can calculate an operation plan for an input power demand. However, the operation plan formulation apparatus disclosed in Patent Literature 1 does not determine an optimum production plan while taking a constraint having a temporal continuity into consideration.

The present disclosure has been made to solve the above-described problem and an object thereof is to provide an information processing apparatus, a production plan determination method, and a non-transitory computer readable medium storing a program that are capable of determining an optimum production plan while taking a constraint having a temporal continuity into consideration.

### Solution to Problem

An information processing apparatus according to the present disclosure includes:

input means for inputting a predicted value of an amount of demand at each of a plurality of times; and

output means for outputting a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

A production plan determination method according to the present disclosure includes:

inputting a predicted value of an amount of demand at each of a plurality of times; and

outputting a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

A non-transitory computer readable medium according to the present disclosure stores a program for causing a computer to:

input a predicted value of an amount of demand at each of a plurality of times; and

output a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

### Advantageous Effects of Invention

According to the present disclosure, it is possible to determine an optimum production plan while taking a constraint having a temporal continuity into consideration.

### BRIEF DESCRIPTION OF DRAWINGS

FIG. 1 is a diagram showing a configuration example of an information processing apparatus according to a first example embodiment;

FIG. 2 is a diagram showing a configuration example of an information processing apparatus according to a second example embodiment;

FIG. 3 is a diagram for explaining a discretization of a demand scenario;

FIG. 4 is a diagram for explaining the discretization of the demand scenario;

FIG. 5 is a diagram for explaining constraints given to a variable y and a variable z;

FIG. 6 is a diagram for explaining an operation example of the information processing apparatus according to the second example embodiment;

FIG. 7 is a diagram for explaining an operation example of the information processing apparatus according to the second example embodiment;

FIG. 8 is a diagram for explaining an operation example of the information processing apparatus according to the second example embodiment; and

FIG. 9 is a diagram showing a configuration example of an information processing apparatus according to other example embodiments.

### DESCRIPTION OF EMBODIMENTS

Hereinafter, example embodiments of the present disclosure will be described with reference to the drawings. Note that in order to clarify the explanation, the following descriptions and the drawings are partially omitted and simplified as appropriate. Further, the same symbols are assigned to the same elements throughout the drawings, and redundant descriptions are omitted as necessary.

### First Example Embodiment

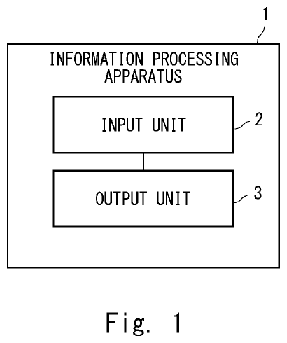

An information processing apparatus 1 according to a first example embodiment is described with reference to FIG. 1. FIG. 1 is a diagram showing a configuration example of the information processing apparatus according to the first example embodiment.

The information processing apparatus 1 is an apparatus that determines a production plan including a planned value of an amount of production in each of at least one production facility for a predicted value of an amount of demand. The amount of demand may be, for example, an amount of demand related to energy resources such as a power demand, a heat demand, and a water demand. Alternatively, the amount of demand may be, for example, an amount of demand for products such as parts produced in a factory or the like.

The amount of production may be an amount of production or an amount of generation related to energy resources such as an amount of generated power, an amount of generated heat, and an amount of generated water. The amount of production may be the number or the amount of products produced in a factory and the like. Note that since it can be considered that the amount of production is the amount to be supplied in accordance with the amount of demand, it may be referred to as an amount of supply, and further a production plan may be referred to as a supply plan. Further, similar to the above case of the amount of production, a production facility may be referred to as a supply facility.

The information processing apparatus 1 may be, for example, a server or a personal computer. The information processing apparatus 1 includes an input unit 2 that functions as input means and an output unit 3 that functions as output means.

The input unit 2 inputs predicted values of the amounts of demand at a plurality of times. The input unit 2 may be, for example, a keyboard, a mouse, a touch panel, or the like. Alternatively, the input unit 2 may be configured to input various types of information from an internal memory or an external server and the like connected to the information processing apparatus 1.

The output unit 3 may be, for example, a display unit such as a display or a touch panel. Alternatively, the output unit 3 may be configured to output various types of information to an internal memory or an external server and the like connected to the information processing apparatus 1.

The output unit 3 outputs a production plan that satisfies a predicted value based on an optimum solution of an optimization model that determines a production plan including a planned value of the amount of production of each production facility at each time up to a predetermined time.

The optimization model is an optimization model in which at consecutive times, a constraint is given to the amount of production of each of at least one production facility and a data range indicating a range of uncertainty is set in the amount of demand. Further, the optimization model is a model that determines a production plan including a planned value of the amount of production each of the at least one production facility at each of the times up to a predetermined time for the amount of demand at each of the times up to the predetermined time.

The predetermined time is, for example, a time at which it can be determined that the range of uncertainty set in the amount of demand is not too wide, and may be, for example, a time 24 hours or 12 hours after the current time, or may be appropriately set. The period of time between each time may be any period of time that can be appropriately changed, for example, it may be 10 seconds or one hour. Further, each time may be a periodic time or a non-periodic time.

The range of uncertainty refers to a data range set by uncertainty included in the amount of demand. The range of uncertainty is, for example, in the case of a power demand, a data range set by uncertainty determined based on a plurality of factors such as temperature, weather, a forecast error, and the like.

As described above, the input unit 2 inputs predicted values of the amounts of demand at a plurality of times. The output unit 3 outputs a production plan for the input predicted values based on an optimum solution of an optimization model. The optimization model determines a production plan including a planned value of the amount of production of each production facility at each time up to a predetermined time for the amount of demand at each time up to the predetermined time. That is, the output unit 3 can output a production plan that satisfies each of the amounts of demand having a temporal continuity for the amount of demand at each time up to a predetermined time based on the optimum solution of the optimization model that determines an optimum production plan. Therefore, by using the information processing apparatus 1 according to the first example embodiment, it is possible to determine an optimum production plan while taking a constraint having a temporal continuity into consideration.

### Second Example Embodiment

Next, a second example embodiment is described. The second example embodiment has a detailed configuration of the first example embodiment.

### <Configuration Example of Information Processing Apparatus>

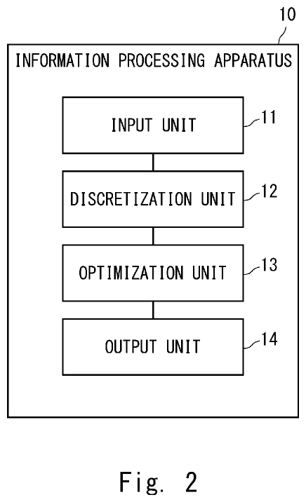

An information processing apparatus 10 according to the second example embodiment is described with reference to FIG. 2. FIG. 2 is a diagram showing a configuration example of the information processing apparatus according to the second example embodiment.

The information processing apparatus 10 corresponds to the information processing apparatus 1 according to the first example embodiment. The information processing apparatus 10 may be, for example, a server or a computer apparatus. Note that the information processing apparatus 10 may comprise two or more servers, two or more computer apparatuses, or one or a plurality of servers and computer apparatuses.

The information processing apparatus 10 is an apparatus that determines a production plan indicating a planned value of the amount of production in each of at least one production facility for the amount of demand by using an optimization model described later.

The amount of demand may be, for example, an amount of demand related to energy resources such as a power demand, a heat demand, and a water demand. Alternatively, the amount of demand may be, for example, an amount of demand for products such as parts produced in a factory or the like.

As described above, since the amount of demand such as a power demand is determined by a plurality of factors, it includes uncertainty. Thus, an uncertain constraint is given to the amount of demand at consecutive times. In other words, at consecutive times, a data range indicating a range of uncertainty is set in the amount of demand.

Further, the amount of production of each production facility cannot be significantly increased or decreased from the amount of production at the immediately previous time. Therefore, a constraint is also given to the amount of production of each production facility at consecutive times.

The information processing apparatus 10 includes an input unit 11 that functions as input means, a discretization unit 12 that functions as discretization means, an optimization unit 13 that functions as optimization means, and an output unit 14 that functions as output means.

The input unit 11 corresponds to the input unit 2 according to the first example embodiment. The input unit 11 inputs predicted values of the amounts of demand at a plurality of times. Further, the input unit 11 inputs an actual value of the amount of demand and an actual value of the amount of production of each production facility. The input predicted value is information serving as a basis for the output unit 14 described later to output an optimum production plan. Further, the actual value of the amount of demand and the actual value of the amount of production of each production facility are used to calculate an optimum solution of the optimization model.

The input unit 11 may be, for example, a keyboard, a mouse, a touch panel, or the like. Alternatively, the input unit 11 may be configured to input various types of information from an internal memory or an external server and the like connected to the information processing apparatus 10.

The discretization unit 12 and the optimization unit 13 calculate an optimum solution of the optimization model.

The discretization unit 12 discretizes values of the amount of demand that can be taken at each time determined based on the actual value of the amount of demand input to the input unit 11 into a predetermined number of demand values. That is, the discretization unit 12 discretizes the values of the amount of demand that can be taken at a time t (t: 1, 2, . . . , T) determined based on the actual value of the amount of demand input to the input unit 11 into a predetermined number of demand values. When the discretization unit 12 discretizes the values of the amount of demand that can be taken at each time up to the time T into a predetermined number of demand values, it outputs the discretized demand values up to the time T to the optimization unit 13. Note that the time 1 is a time before the current time, and the actual value of the amount of demand and the actual value of the amount of production of each production facility are used.

Note that the period of time between the time t−1 and the time t may be any period of time that can be appropriately changed, for example, 10 seconds or one hour. Further, the time t−1 and the time t may each be a periodic time or a non-periodic time. That is, the period of time from the time t−1 to the time t and the period of time from the time t to time t+1 may or may not be the same. Further, the time T may be any time at which it can be determined that the range of uncertainty set in the amount of demand does not become too wide. For example, it may be a time 24 hours or 12 hours after the current time.

As will be described later in detail, the amount of demand is not a value uniquely determined because a data range indicating a range of uncertainty is set. Thus, it is difficult to obtain an optimum solution of the optimization model that determines an optimum production plan for the amount of demand as it is. Therefore, at the time t, the discretization unit 12 discretizes the values of the amounts of demand that can be infinitely taken within the data range indicating the range of uncertainty into a predetermined number of demand values.

The optimization unit 13 receives the discretized demand value at each time up to the time T from the discretization unit 12, and calculates an optimum solution of the optimization model at each time up to the time T for the discretized demand value at each time up to the time T by using the actual value of the amount of production of each production facility. Note that the details of the optimization model and the calculation of the optimum solution will be described later.

The output unit 14 corresponds to the output unit 3 according to the first example embodiment. The output unit 14 may be, for example, a display unit such as a display or a touch panel. Alternatively, the output unit 14 may be configured to output various types of information to an internal memory or an external server and the like connected to the information processing apparatus 10.

The output unit 14 outputs, based on the optimum solution of the optimization model, a production plan including a planned value of the amount of production of each production facility for the input predicted values of the amounts of demand. Specifically, the output unit 14 outputs the production plan for the input predicted values based on the optimum solutions for the discretized demand values calculated by the optimization unit 13. Note that processing in which the output unit 14 outputs a production plan for the input predicted values based on the optimum solution of the optimization model will be further described after the description of the optimization model and the description of processing for calculating an optimum solution of the optimization model are given.

The output unit 14 may output a range of the amount of production of each production facility for the input amount of demand. Alternatively, the output unit 14 may graph and output the range of the amount of production of each production facility for the input amount of demand.

As described above, at consecutive times, the range of uncertainty is set in the amount of demand, and further a constraint is given to the amount of production of each production facility. Therefore, in the optimization model, at consecutive times, a constraint is given to the amount of production of each production facility and the range of uncertainty is set in the amount of demand. Further, the optimization model is a model that determines a production plan for the amount of demand at the time t by using the amount of demand up to the time t−1 and the production plan up to the time t−1.

The optimization model is described in detail below. Note that in the description of the optimization model, contents of processing executed by the discretization unit 12 and the optimization unit 13 are also be described.

### <Optimization Model>

The optimization model is a model that determines an optimum production plan for input predicted values of the amounts of demand, and is specifically a model in which an optimization problem described below is formulated.

In the following description, examples related to a power demand and a power generation plan are used. Note that the power demand is a specific example of the amount of demand in the first example embodiment, and the power generation plan is a specific example of the production plan in the first example embodiment. A generator is a specific example of the production facility in the first example embodiment, and the amount of generated power is a specific example of the amount of production in the first example embodiment. Note that, as a matter of course, the examples related to the power demand and the power generation plan are merely examples, and thus the present disclosure is not limited thereto.

The optimization problem formulated as the optimization model may be an optimization problem of the amount of production such as the amount of generated heat and the amount of water of each production facility such as a plant for the amount of demand related to energy resources such as a heat demand and a water demand. Alternatively, it may be an optimization problem of the number or the amount of products produced in a factory, a production line, and the like for the amount of demand for products such as parts.

The optimization model is described below, while the history of the examination conducted by the present inventors is given and the optimization problem assumed in this example embodiment is embodied.

First, an optimum power generation plan is a power generation plan that satisfies the power demand at each time and minimizes a cost. Further, the amount of production of each production facility depends on the amount of production at the immediately previous time and cannot be significantly changed from the amount of production at the immediately previous time, so that a constraint is set in the amount of production of each production facility. Based on the above, the relation between the power demand and the power generation plan, and the constraint on the amount of production of each production facility can be expressed as Expressions (1) to (3).

$$\begin{matrix}\begin{matrix}min {\sum }_{t = 1}^{T} c ( {x}^{( t )} ) & \end{matrix} & ( 1 ) \\ \begin{matrix}s . t . {\sum }_{n = 1}^{N} {x}_{n}^{( t )} = {d}^{( t )} & ( t = 1 , . . . , T )\end{matrix} & ( 2 ) \\ \begin{matrix}l ( {x}^{( t )} ) \leq {x}^{( t + 1 )} \leq u ( {x}^{( t )} ) & ( t = 1 , . . . , T - 1 )\end{matrix} & ( 3 )\end{matrix}$$

t represents a time, and c(x^{(t)}) is a cost based on the amount of production at the time t. n is a number specifying a generator (a production facility), and N is the total number of generators (production facilities). xₙ^{(t)} is the amount of production of the generator (the production facility) n at the time t, and d^{(t)} is the power demand (the amount of demand) at the time t. l(x^{(t)}) is a function for calculating a lower limit value of the amount of power generated by the generator at the time t, and u(x^{(t)}) is a function for calculating an upper limit value of the amount of power generated by the generator at the time t. In Expression (3), l(x^{(t)}) and u(x^{(t)}) represent all the production facilities as vectors, and each production facility is expressed as follows.

lₙ(xₙ^{(t)})≤xₙ^{(t+1)}≤uₙ(xₙ^{(t)})(t=1, . . . ,T−1)

It should be noted that when the power demand is uniquely determined, the power generation plan can be calculated based on the above Expressions (1) to (3). However, future power demand cannot be uniquely determined, because it is determined instead by a plurality of factors. Specifically, the power demand is determined by a plurality of factors such as temperature, weather, a forecast error, and the like. Therefore, an uncertain data range (a range of uncertainty) determined by a plurality of factors is set in the power demand.

Incidentally, the uncertainty of a power demand increases as time advances. It is possible to forecast, for example, temperature and weather after one day to some extent based on the present situation. Therefore, it is possible to reduce the uncertainty of the power demand after one day. On the other hand, it is difficult to forecast, for example, temperature and weather after one week based on the present situation, whereby it is difficult to determine the power demand. Accordingly, the uncertainty of the power demand after one week increases. As described above, the uncertainty of the power demand increases as time advances. Therefore, in order to reduce the uncertainty of the power demand, it is necessary to make a decision to replan a power generation plan at a certain timing.

Meanwhile, for example, assuming that a generator is a thermal power generator, the thermal power generator requires about 12 hours to start up. Therefore, it is necessary to determine a power generation plan in which the start-up time of the thermal power generator is taken into consideration. That is, it is necessary to make an early decision to replan a power generation plan. Therefore, it is important to ascertain when to perform replanning before making a decision.

Therefore, in this example embodiment, it will be examined that even when an uncertain constraint is given to the power demand, a robust optimization problem is formulated based on the assumption of replanning, an optimum solution of the formulated robust optimization problem is obtained, and an optimum power generation plan for an input power demand is determined.

First, when an uncertain constraint is given to the power demand (when the range of uncertainty is set in the power demand) at each time, it is formulated that a plan for each time is developed based on replanning. At this time, since the range of uncertainty is set in the power demand, the formulation including the content of this constraint is made. When the aforementioned content is formulated, it can be expressed as the following Expressions (4) to (7).

$$\begin{matrix}\begin{matrix}{min}_{{x}^{( 1 )}} {max}_{{d}^{( 2 )}} . . . {min}_{{x}^{( T - 1 )}} {max}_{{d}^{( T )}} {min}_{{x}^{( T )}} {\sum }_{t = 1}^{T} c ( {x}^{( t )} ) & \end{matrix} & ( 4 ) \\ \begin{matrix}s . t . {\sum }_{n = 1}^{N} {x}_{n}^{( t )} = {d}^{( t )} & ( t = 1 , . . . , T )\end{matrix} & ( 5 ) \\ \begin{matrix}l ( {x}^{( t )} ) \leq {x}^{( t + 1 )} \leq u ( {x}^{( t )} ) & ( t = 1 , . . . , T - 1 )\end{matrix} & ( 6 ) \\ \begin{matrix}{d}^{( t + 1 )} ∈ U ( {d}^{( 1 )} , . . . , {d}^{( t )} ) & ( t = 1 , . . . , T - 1 )\end{matrix} & ( 7 )\end{matrix}$$

The above Expression (4) expresses an optimization problem of determining an optimized power generation plan based on the replanning, and expresses an optimization model. The optimization model is a model in which an optimization problem of determining an optimum production plan for the amount of demand up to a predetermined time (the time T) is formulated by the above Expressions (4) to (7).

The variables of Expression (4) correspond to the variables of Expression (1). Expression (4) is an expression that formulates that the power demand at a time 2 is determined based on the power demand at a time 1, the power generation plan at the time 2 is determined based on the power demand at the time 2, . . . , and the power generation plan at the time T is determined based on the power demand at the time T.

Expressions (5) and (6) correspond to Expressions (2) and (3), respectively, and the variables of Expressions (5) and (6) correspond to the variables of the Expressions (2) and (3), respectively.

Next, Expression (7) expresses the relation between the power demand at a time t+1 and the power demand from the time 1 to the time t, and U(d⁽¹⁾, . . . ,d^{(t)}) is a function for determining the range of uncertainty of the power demand. That is, Expression (7) expresses that the range of uncertainty of the power demand at the time t+1 is determined using the power demand from the time 1 to the time t as variables.

A function U in Expression (7) is a function determined in accordance with an existing prediction model that determines a power demand, and is also referred to as a predictor. That is, the function (the predictor) U is a known function determined in accordance with the prediction model.

The function U is described below. For example, assume a case in which a region of U(d⁽¹⁾, d⁽²⁾, . . . , d^{(t)}) is to be calculated for the power demand (d⁽¹⁾,d⁽²⁾, . . . ,d^{(t)}) at each time. If the prediction model of the power demand is an autoregressive model for the normal noise, it can be expressed as shown in Expression (8).

d^{(t+1)}=a₀d^{(t)}+a₁d^{(t-1)}+ . . . +aₜ₋₁d⁽¹⁾+aₜ+ϵε˜N(0,σ²) (8)

At this time, U(d⁽¹⁾,d⁽²⁾, . . . ,d^{(t)} can be designed as a trust region of, for example, 3σ(99.8%), and in this case, the function U can be defined as shown in

Expression (9).

U(d⁽¹⁾, . . . , d^{(t)})=[a₀d^{(t)}+a₁d^{(t-)}+ . . . +aₜ₋₁d⁽¹⁾+aₜ−3σ,a₀d^{(t)}+a₁d^{(t-1)}+ . . . +aₜ₋₁d⁽¹⁾+aₜ+3σ] (9)

As described above, the function (the predictor) U of Expression (7) can be determined in accordance with the prediction model that determines a power demand as shown in Expression (9). Note that the above is merely an example, and the function U can instead be set based on the prediction model to be used and the reliability to be set.

### <Processing for Calculating Optimum Solution of Optimization Model>

Next, processing for calculating an optimum solution of the optimization problem (the optimization model) formulated by Expressions (4) to (7) is described. In order to determine an optimum power generation plan (a production plan) for the power demand (the amount of demand), it is necessary to obtain the optimum solution of the optimization model (the optimization problem) formulated by Expressions (4) to (7). Therefore, an obtaining of the optimum solution of the optimization model will be considered below.

As shown in Expression (7), since the power demand at the time t+1 has the range of uncertainty, there are an infinite number of transition patterns of the power demand between the time t and the time t+1. Note that in the following description, the transition pattern of the power demand is referred to as a demand scenario.

Specifically, since the range of uncertainty is set in the power demand at the time t, values of the power demand that can be taken are not finite. Similarly, since the range of uncertainty is set in the power demand at time t+1, values of the power demand that can be taken are not finite. Therefore, the demand scenarios at the time t and the time t+1 are continuous and there are an infinite number of demand scenarios. Thus, it is generally extremely difficult to obtain the optimum solution of the optimization problem formulated by Expression (4), and therefore the optimization problem cannot be solved as it is. Note that if this optimization problem can be solved, a robust plan based on the assumption of replanning can be calculated. That is, it is possible to determine an optimum power generation plan that guarantees the power demands at all times.

Therefore, in order to solve the optimization problem formulated by Expression (4), the demand scenario is discretized based on a graph. Note that the demand scenario is discretized by the discretization unit 12.

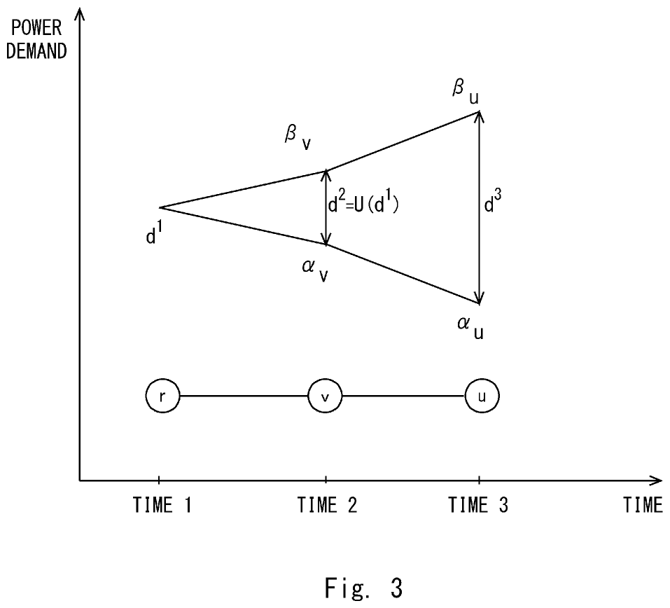

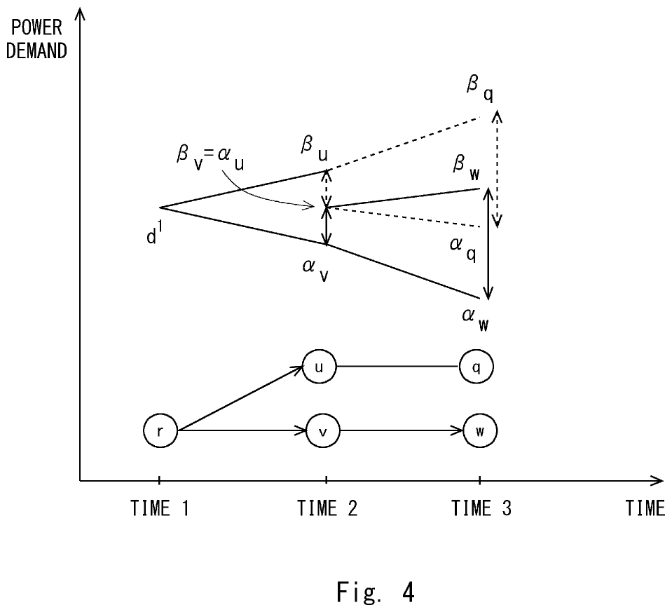

A discretization of the demand scenarios based on the graphs is described below with reference to FIGS. 3 and 4. FIGS. 3 and 4 are diagrams for explaining the discretization of the demand scenarios. Specifically, FIG. 3 shows a state before the demand scenario is discretized. FIG. 4 shows a state after the demand scenario is discretized.

First, FIG. 3 is described. The horizontal axis is an axis regarding a time, and the vertical axis is an axis regarding demand. The power demands of the times 1 to 3, respectively, are set to d¹, d², and d³. It is assumed that the maximum value of the power demand at the time 2 is βᵥ, the minimum value of the same is αᵥ, the maximum value of the power demand at the time 3 is βᵤ, and the minimum value of the same is αᵤ.

The discretization unit 12 regards the values of the power demands or the data ranges of the power demands as nodes so that the relation among the power demands at the respective times can be understood, and generates relation information between the nodes. Specifically, the discretization unit 12 regards the power demand d¹ at the time 1 as a node r, the power demand d² at the time 2 as a node v, and the power demand d³ at the time 3 as a node u. Then, the discretization unit 12 generates relation information between the nodes as, for example, r-v-u.

As shown in FIG. 3, the power demand d² at the time 2 has a wider data range than that of the power demand d¹ at the time 1. This is due to the uncertainty of the power demand, and the width set in the power demand d² is a data range indicating the range of uncertainty. Next, the power demand d³ at the time 3 has a wider data range than that of the power demand d² at the time 2. As described above, the data range increases with time.

FIG. 3 shows a state of the power demand of Expression (7). However, as described above, the optimization problem of Expression (4) cannot be solved as it is. Therefore, in order to solve the optimization problem of Expression (4), the demand scenario is discretized as shown in FIG. 4.

FIG. 4 shows a state after the demand scenario is discretized. As in the case of FIG. 3, the horizontal axis is an axis regarding a time, and the vertical axis is an axis regarding demand. As shown in FIG. 3, since the uncertainty of the power demand propagates with time, the data range expands with time.

Therefore, in order to narrow the data range indicating the range of uncertainty of the power demand, the discretization unit 12 divides the data range at the time (the time 2) immediately previous to the time (the time 3) at which the power generation plan (the optimum solution) is desired to be obtained into a predetermined number of data ranges. In this example embodiment, a description is given in accordance with the assumption that the data range at the time 2 is divided into two data ranges.

Note that in this example embodiment, although the description is given in accordance with the assumption that the data range at the time 2 is divided into two data ranges, the greater the number of data ranges which the data range is divided into, the more finely the demand scenario can be divided. That is, if the data range can be infinitely, finely divided, this would be equivalent to solving the optimization problem of Expression (4). However, the greater the number of data ranges which the data range is divided into, the greater the amount of time it takes to calculate an optimum solution, so that a trade-off occurs between the calculation time and the quality of the solution to be calculated. Therefore, the number of data ranges which the data range is divided into can be appropriately determined by a user, and may be appropriately changed.

When the discretization unit 12 divides the data range at the time 2, two divided data ranges are generated as shown at the time 2 in FIG. 4. The discretization unit 12 sets the values of the data range at the time 2 as the node v and the node u in the order of the values of relatively small power demands. That is, the discretization unit 12 sets v and u for each data range in order from the bottom of the graph. In the following description, the data range in which the node v is set is defined as a data range v, and the data range in which the node u is set is defined as a data range u.

Further, the discretization unit 12 sets an index for each data range at the time 2 in order from the bottom of the graph. That is, an index 1 is set for the data range v, and an index 2 is set for the data range u.

Next, the discretization unit 12 determines (sets) the data range at the time 3 for each of the data range v and the data range u by using the function U, and sets nodes for each of the data ranges. A node w is set in a data range of the data range at the time 3 determined from the data range v, and this data range is defined as a data range w. A node q is set in a data range of the data range at time 3 determined from the data range u, and this data range is defined as a data range q. Then, the discretization unit 12 generates relation information between the nodes. The relation information between the nodes is shown in the lower part of the graph of FIG. 4.

By branching the demand scenario as shown in FIG. 4, the discretization unit 12 only needs to consider the demand scenario of the power demand for the branched scenario. Therefore, the discretization unit 12 branches the demand scenario as described above.

In FIG. 4, only the times 1 to 3 are shown. However, as a matter of course, there may be a time 4 and later. For example, when a power generation plan (an optimum solution) at the time t is desired to be obtained, the demand scenario may be discretized for each data range at the time t−1. That is, the discretization unit 12 divides each data range at the time t−1 into a predetermined number of data ranges, and sets a data range indicating the range of uncertainty at the time t for each of the divided data ranges by using the function U. Then, the discretization unit 12 sets nodes for the data ranges at the time t−1 and the data ranges at the time t, and generates relation information between the nodes. When this processing is referred to as discretization processing, the discretization unit 12 repeats the discretization processing until a predetermined time (the time T).

At the time T, when the above content is generalized and expressed as a mathematical expression, it can be expressed as the following Expressions (10) to (12). Expression (10) is an expression that describes a demand scenario to be branched to the node v (the data range v). ch(r) indicates that the node v is a child node of the node r. Note that it is assumed that P(v) represents a parent node of the node v in the following description, although this assumption is not stated here.

$$\begin{matrix}\begin{matrix}{min}_{{x}^{( 1 )}} {max}_{{{v}_{2} ∈ ch ( r )}_{{d}^{( 2 )} ∈ {D}_{{v}_{2}}}} . . . {min}_{{x}^{( T - 1 )}} {max}_{{{v}_{T} ∈ ch ( {v}_{T - 1} )}_{{d}^{( T )} ∈ {D}_{{v}_{T}}}} {min}_{{x}^{( T )}} {\sum }_{t = 1}^{T} c ( {x}^{( t )} ) & \\ {D}_{v} := [ {α}_{v} , {β}_{v} ] & \end{matrix} & ( 10 ) \\ \begin{matrix}s . t . {\sum }_{n = 1}^{N} {x}_{n}^{( t )} = {d}^{( t )} & ( t = 1 , . . . , T )\end{matrix} & ( 11 ) \\ \begin{matrix}l ( {x}^{( t )} ) \leq {x}^{( t + 1 )} \leq u ( {x}^{( t )} ) & ( t = 1 , . . . , T - 1 )\end{matrix} & ( 12 )\end{matrix}$$

As described above, the discretization unit 12 divides the data range and branches the demand scenario. By doing so, the data ranges at the times 2 and 3 can be narrowed from the state shown in FIG. 3, and Expression (4) can be transformed into Expression (10). However, like Expression (4), Expression (10) has a structure having both a maximization problem and a minimization problem, and accordingly the optimum solution to the optimization problem cannot be obtained at this point in time.

Therefore, the discretization unit 12 discretizes, into a predetermined number of demand values, values of the power demand that can be taken for the divided data ranges. By doing so, it is possible to solve the optimization problem expressed by the original Expression (4). Specifically, the discretization unit 12 discretizes the values of the power demand that can be taken in the data ranges set using the function U from each of the divided data ranges into endpoints (upper and lower limit values).

Next, the optimization unit 13 calculates an optimum solution to the optimization problem of Expression (10). Specifically, in each data range, the optimization unit 13 calculates an optimum solution to the optimization problem of Expression (10) for the end endpoints (the upper and lower limit values) obtained by discretizing the values of the power demand that the discretization unit 12 can take.

It is assumed here that in each data range, the lower end point (the lower limit value) is α and the upper end point (the upper limit value) is β. For example, in the data range v (the node v), the lower endpoint (the lower limit value) is αᵥ and the upper endpoint (the upper limit value) is βᵥ. Further, in the data range u (the node u), the lower end point (the lower limit value) is αᵤ and the upper end point (the upper limit value) is βᵤ. Note that as shown in FIG. 4, the data ranges v and u are continuous data ranges, and the upper end point of the data range v and the lower end point of the data range u have the same value, so that the relation βᵥ=αᵤ holds.

Next, a variable corresponding to the lower end point (the lower limit value) is defined as a variable y, and a variable corresponding to the upper end point (the upper limit value) is defined as a variable z. The variable y is a variable for determining a power generation plan corresponding to the lower end point. The variable z is a variable for determining a power generation plan corresponding to the upper end point. The power generation plan for the variables y and z can be expressed as follows. y_{v,n} represents the amount of power generated by a generator n corresponding to the lower end point of the power demand in the data range v (the node v). z_{v,n} represents the amount of power generated by the generator n corresponding to the upper end point of the power demand in the data range v (the node v).

$$\begin{matrix}\begin{matrix}min ω & \end{matrix} & ( 13 ) \\ \begin{matrix}s . t . ω \geq c ( x ) & for x ∈ \{ y , z \}\end{matrix} & ( 14 ) \\ \begin{matrix}{\sum }_{n = 1}^{N} {y}_{v , n} = {α}_{v} & \end{matrix} & ( 15 ) \\ \begin{matrix}{\sum }_{n = 1}^{N} {z}_{v , n} = {β}_{v} & \end{matrix} & ( 16 )\end{matrix}$$

The discretization unit 12 divides the data range of the power demand, and discretizes the values that can be taken in a data range set using the function U for each of the divided data ranges into the upper and lower end points of the data range. Thus, as in the case of the above Expression (13), Expression (10) (Expression (4)) can be replaced with a minimization problem, and the optimization unit 13 can determine an optimum solution (a power generation plan).

However, at the time 3, the power generation plan may not be a power generation plan that satisfies the constraints for all the demand scenarios by only the above Expressions (13) to (16). Therefore, at the time 2, it is necessary to calculate a power generation plan that satisfies the constraints for all the demand scenarios. Therefore, considering the case in which the power generation plans are most changed from the power generation plans at the upper end point (the upper limit value) and the lower end point (the lower limit value) of the data range v at the time 2, constraints are given to the variables y and z for determining the optimum power generation plan.

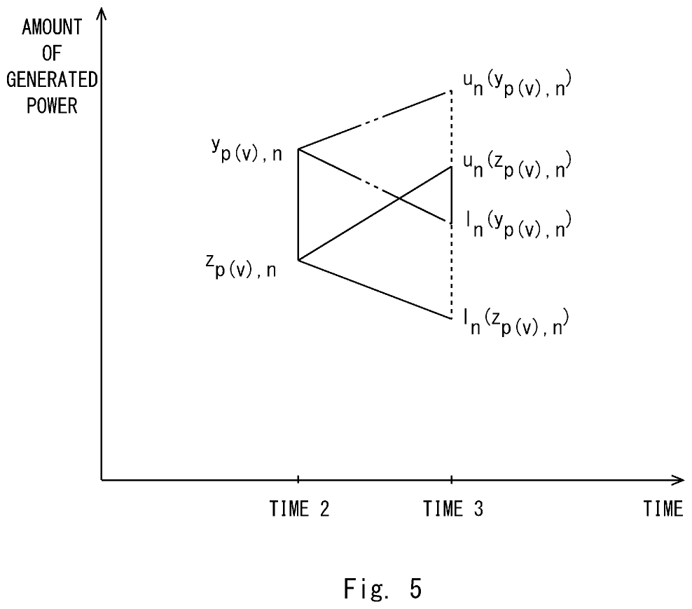

The constraints given to the variables y and z to be set are described with reference to FIG. 5. FIG. 5 is a diagram for explaining the constraints given to the variables y and z. Further, FIG. 5 is a diagram for explaining the constraint between the power generation output at the time 2 and the power generation output at the time 3. In FIG. 5, the horizontal axis represents the time, and the vertical axis represents the amount of power generated by the generator n.

For the sake of simplification and convenience of the description, it is assumed that the upper limit value of the generated power at the time 2 is y_{p(v),n}, and the lower limit value of the generated power at the time 2 is z_{p(v),n}. Note that the variable giving the maximum value of the power generated by the generator n may actually be y_{p(v),n} or z_{p(v),n}. For example, it is conceivable that the generator n may generate the lowest amount of power and another generator may generate the highest amount of power. Further, on the contrary, it is conceivable that the generator n may generate the highest amount of power and another generator may generate the lowest amount of power. That is, it is not known which of y_{p(v),n} and z_{p(v),n} is the lower limit value and which of the same is the upper limit value of the generated power at the time 2.

Continuing the description, consider setting the constraint on the amount of generated power at the time 3 so that it satisfies the upper and lower limit constraints on any amount of generated power at the time 2 and does not depend on the amount of generated power at the time 2. In order to achieve this setting, as the upper limit of the amount of generated power at the time 3, a value when the amount of generated power is most increased from the lower limit value of the generated power at the time 2 may be set, and as the lower limit of the generated power at the time 3, a value when the generated power is most reduced from the upper limit value of the generated power at the time 2 may be set.

The solid line in FIG. 5 shows the amounts of generated power that can be taken at the time 3 which satisfy the constraints on the amounts of generated power shown in Expressions (6) and (12) with respect to the lower limit value of the amount of generated power at the time 2. The alternate long and three short dashes line in FIG. 5 shows the amounts of generated power that can be taken at the time 3 which satisfy the constraints on the amounts of generated power shown in Expressions (6) and (12) with respect to the upper limit value of the amount of generated power at the time 2.

It should be noted that in FIG. 5, with respect to the upper and the lower limit values of the generated power at the time 2, there is a range in which the amounts of generated power that can be taken at the time 3 which satisfy the constraints on the amounts of generated power shown in Expressions (6) and (12) are overlapped with each other. If the amount of power generated at the time 3 is included in this overlapping range, the constraint in the case of the upper limit value of the amount of power generated at the time 2 is satisfied, and the constraint in the case of the lower limit value of the amount of power generated at the time 2 is satisfied. Therefore, the amount of power generated by the generator which satisfies the condition (the constraint) that the amount of power generated at the time 3 is included in the overlapping range is determined.

Further, in addition to the above, as shown in FIG. 4, the divided data range at the time 3 is a data range divided from the same parent node and sharing one end with an adjacent (continuous) divided data range. In regard to the one end shared by the divided data range and the adjacent (continuous) divided data range, it is necessary to have the same power generation plan as each other. Therefore, it is also set as a condition (a constraint) that in the continuous divided data ranges divided from the same parent node at the time 3, the optimum solution for the upper limit value of a first data range and the optimum solution for the lower limit value of a second data range coincide with each other. Note that in the first data range, the lower limit value is lower than that of the second data range.

When the aforementioned conditions (constraints) are expressed as mathematical expressions, they can be expressed as the following Expressions (17) to (19). Note that as described above, it is conceivable that the upper limit value of the generator n may be y_{p(v),n} or z_{p(v),n}, so that it is generalized and described. Further, the following Expressions are conditions (constraints) to be set for obtaining Expressions (13) to (16), and thus Expressions (13) to (16) are also described.

$$\begin{matrix}\begin{matrix} min ω & \end{matrix} & ( 13 ) \\ \begin{matrix} s . t . ω \geq c ( x ) & for x ∈ \{ y , z \}\end{matrix} & ( 14 ) \\ \begin{matrix} {\sum }_{n = 1}^{N} {y}_{v , n} = {α}_{v} & \end{matrix} & ( 15 ) \\ \begin{matrix} {\sum }_{n = 1}^{N} {z}_{v , n} = {β}_{v} & \end{matrix} & ( 16 ) \\ \begin{matrix}max \{ l ( {y}_{p ( v )} ) , l ( {z}_{p ( v )} ) \} \leq {y}_{v} \leq min \{ u ( {y}_{p ( v )} ) , u ( {z}_{p ( v )} ) \} & for v ∈ V \backslash \{ r \}\end{matrix} & ( 17 ) \\ \begin{matrix}max \{ l ( {y}_{p ( v )} ) , l ( {z}_{p ( v )} ) \} \leq {z}_{v} \leq min \{ u ( {y}_{p ( v )} ) , u ( {z}_{p ( v )} ) \} & for v ∈ V \backslash \{ r \}\end{matrix} & ( 18 ) \\ \begin{matrix}{y}_{v} = {z}_{v} , & for v , {v}^{′} ∈ V \backslash \{ r \} if p ( v ) = p ( {v}^{′} ) and k ( v ) = k ( {v}^{′} ) + 1\end{matrix} & ( 19 )\end{matrix}$$

Expressions (17) and (18) express a constraint that the amount of generated power at the time t is included between the amount of generated power when it is most reduced from the upper limit value of the amount of generated power at the time t−1 and the amount of generated power when it is most increased from the lower limit value of the amount of generated power at the time t−1. That is, Expressions (17) and (18) express that the amount of generated power at the time t is included between the minimum value within a range of the constraint on the amount of generated power for the upper limit value of the amount of generated power at the time t−1 and the maximum value within a range of the constraint on the amount of generated power for the lower limit value of the amount of generated power at the time t−1. In other words, it is necessary to determine the amount of generated power at the time t that satisfies both of Expressions (17) and (18) at the consecutive times up to the time t.

Further, Expression (19) expresses that in the continuous divided data ranges divided from the same parent node at the time t, the amount of generated power for the upper limit value of the first data range having a small index number and the amount of generated power for the lower limit value of the second data range coincide with each other. Note that in Expression (19), k represents an index of the divided data range.

As described above, Expressions (4) to (7) can be expressed as Expressions (13) to (19) by discretizing the demand scenarios and the values of the power demand. Expression (13) becomes a minimization problem of minimizing ω, that is, it no longer has both a maximization problem and a minimization problem, so that it becomes a problem that can be solved. The optimization unit 13 calculates optimum solutions for the upper and the lower limit values of each divided data range at the respective times by solving Expressions (13) to (19).

As described above, it is possible to calculate the optimum solutions for the upper and the lower limit values of each divided data range, but it is necessary to calculate the optimum solution for the power demand between the upper and the lower limit values of each divided data range. Therefore, the optimization unit 13 calculates a ratio of the distance between the power demand for which the optimum solution is desired to be obtained and the upper limit value of each divided data range to the distance between the power demand for which the optimum solution is desired to be obtained and the lower limit value of each divided data range. Then, the optimization unit 13 calculates an optimum solution for the power demand for which the optimum solution is desired to be obtained by using the optimum solutions for the upper and the lower limit values of each divided data range and the calculated ratio. In this way, the optimization unit 13 can calculate an optimum solution of the optimization model formulated by Expressions (4) to (7).

For example, it is assumed that the ratio of the distance between the power demand for which the optimum solution is desired to be obtained and the upper limit value of each divided data range to the distance between the power demand for which the optimum solution is desired to be obtained and the lower limit value of each divided data range is 1−γ:γ. Further, it is assumed that the optimum solution for the upper limit value of each divided data range is z_{v,n}, and the optimum solution for the upper limit value of each divided data range is y_{v,n}. Then, the solution for the power demand for which the optimum solution is desired to be obtained is calculated by (1−γ)y_{v,n}+γz_{v,n}.

### <Output Processing of Output Unit>

The optimization model, and the processing for calculating an optimum solution of the optimization model have been described above, and a description is now given of output processing in which the output unit 14 outputs a power generation plan for input predicted values of the power demand based on the optimum solution of the optimization model.

When the output unit 14 receives the input predicted values from the input unit 11, it specifies the data range or the divided data range to which the input predicted value belongs based on the relation information between the nodes generated by the discretization unit 12. In other words, the output unit 14 specifies, based on the relation information, which demand scenario among the discretized scenarios the input predicted value corresponds to.

Next, the output unit 14 determines a power generation plan for the input predicted value at each of the times based on the optimum solutions for the upper and the lower limit values of the specified data range. In other words, the output unit 14 determines the power generation plan for the input predicted value based on the optimum solutions for the upper and the lower limit values of the divided data range or the data range, including the input predicted value. That is, the output unit 14 determines an optimum composition of the amount of power generated by each generator for the input predicted value.

When the input predicted value is a value between the upper limit value and the lower limit value of the specified data range, the output unit 14 calculates a ratio of the distance between the predicted value and the upper limit value of the specified data range to the distance between the predicted value and the lower limit value of the specified data range. Then, the output unit 14 calculates an optimum solution for the power demand for which the optimum solution is desired to be obtained based on the optimum solutions for the upper and the lower limit values and the calculated ratio, and determines the composition of the amount of power generated by each generator.

For example, it is assumed that the ratio of the distance between the input predicted value and the upper limit value of the divided data range including this input predicted value to the distance between the input predicted value and the lower limit value of the divided data range including this input predicted value is 1−γ:γ. Further, it is assumed that the optimum solution for the upper limit value of each divided data range is z_{v,n}, and the optimum solution for the upper limit value of each divided data range is y_{v,n}. In this case, for the input predicted value, the output unit 14 calculates and determines the composition of the amount of power generated by each generator by (1−γ)y_{v,n}+γz_{v,n}.

### <Operation Example of Information Processing Apparatus>

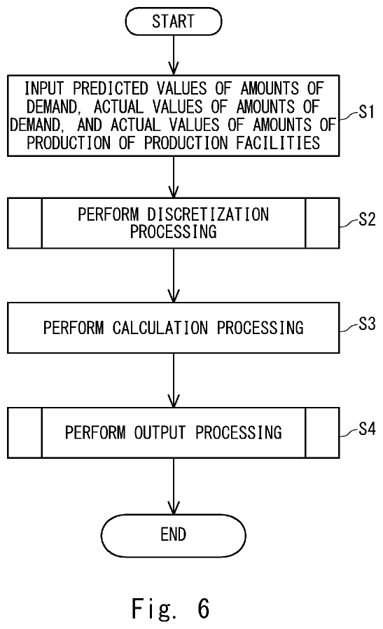

Next, an operation example of the information processing apparatus 10 is described with reference to FIGS. 6 to 8. FIGS. 6 to 8 are diagrams for explaining the operation example of the information processing apparatus according to the second example embodiment.

The overall operation of the information processing apparatus 10 is described with reference to FIG. 6. Note that it is assumed that the time 1 is the current time and the time T is a time at which it can be determined that the range of uncertainty set in the amount of demand does not become too wide.

First, the input unit 11 inputs predicted values of the amounts of demand, actual values of the amounts of demand, and actual values of the amounts of production of the production facilities at a plurality of times (Step S1).

Next, the discretization unit 12 performs discretization processing for discretizing the value of the amount of demand that can be taken at each time from the time 2 to the time T into a predetermined number of demand values (Step S2).

Next, the optimization unit 13 receives, from the discretization unit 12, the discretized demand value at each time from the time 2 to the time T, and calculates an optimum solution of the optimization model for the discretized demand value at each time from the time 2 to the time T (Step S3).

Specifically, the optimization unit 13 determines an optimum solution for the discretized demand value at each time from the time 2 to the time T by using the above-described Expressions (13) to (19). In other words, the optimization unit 13 calculates, as an optimum solution, a planned value of the amount of production of each production facility which satisfies the constraints of Expressions (14) to (19) at all the consecutive times for the discretized demand value at each time from the time 2 to the time T.

The output unit 14 determines, based on the optimum solution calculated by the optimization unit 13, a production plan indicating the planned value of the amount of production of each production facility for the predicted values of the amounts of demand at the plurality of times input to the input unit 11, and outputs the production plan (Step S4).

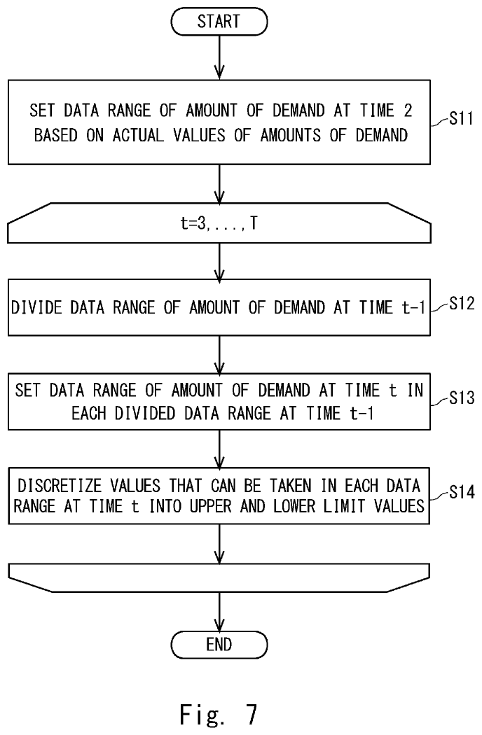

Next, the discretization processing performed in Step S2 of FIG. 6 is described with reference to FIG. 7.

The discretization unit 12 sets a data range indicating uncertainty of the amount of demand at the time 2 based on the actual values of the amounts of demand input to the input unit 11 in Step S1 of FIG. 6 (Step S11).

The discretization unit 12 repeatedly performs Steps S12 to S14 from the time 3 to the time T.

In Step S12, the discretization unit 12 divides the data range of the amount of demand at the time t−1 into two data ranges (Step S12). Note that in this example embodiment, the example in which the data range is divided into two data ranges is described, but the number of data ranges which the data range is divided into may be appropriately determined by a user.

Next, the discretization unit 12 sets the data range of the amount of demand at the time t for each divided data range at the time t−1 by using the function U shown in Expression (9) (Step S13). The discretization unit 12 regards each data range as a node (sets a node for each data range) so that the relation between each divided data range at the time t−1 and the data range at the time t can be understood, and generates relation information between the nodes.

Next, the discretization unit 12 discretizes the values that can be taken in each data range at the time t into the upper limit value and the lower limit value (Step S14). When the discretization unit 12 discretizes the values of the amounts of demand that can be taken at each time until the time T into a predetermined number of demand values, the discretization unit 12 outputs the discretized demand values to the optimization unit 13.

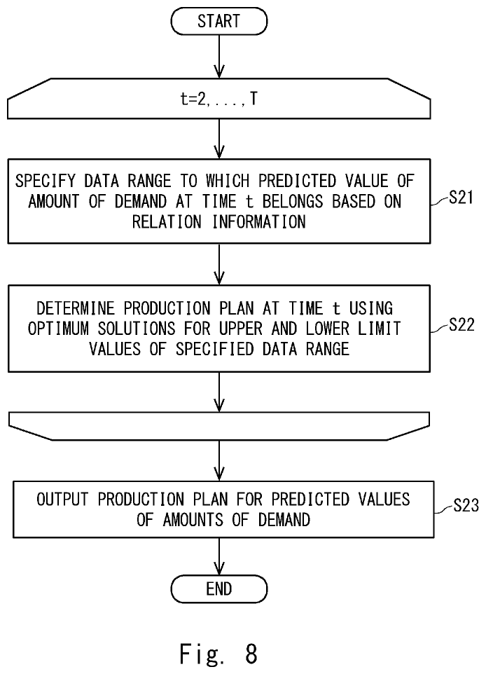

Next, the output processing performed in Step S4 of FIG. 6 is described with reference to FIG. 8.

The output unit 14 repeatedly performs Steps S21 and S22 from the time 2 to the time T.

In Step S21, the output unit 14 specifies a data range to which the predicted value of the amount of demand at the time t belongs based on the relation information between the nodes set in each data range, the relation information being generated by the discretization unit 12 (Step S21).

When the output unit 14 specifies the data range to which the predicted value of the amount of demand at the time t belongs, the output unit 14 determines a production plan at the time t using the optimum solutions for the upper and the lower limit values of the data range calculated by the optimization unit 13 (Step S22).

Specifically, when the input predicted value is a value between the upper and the lower limit values of the specified data range, the output unit 14 calculates a ratio of the distance between the predicted value and the upper limit value of the specified data range to the distance between the predicted value and the lower limit value of the specified data range. Then, the output unit 14 determines a production plan including the planned value of each production facility for the predicted value of the amount of demand at each of the times based on the optimum solutions for the upper and the lower limit values and the calculated ratio.

Lastly, the output unit 14 outputs the production plan for the predicted values of the amounts of demand at the plurality of times input to the input unit 11 (Step S23).

As described above, the optimization model has been defined in which a robust optimization problem is formulated based on the assumption of replanning even when an uncertain constraint is given to the amount of demand. In order to calculate an optimum solution of the optimization model, the discretization unit 12 discretizes the demand scenarios and discretizes the values which the amount of demand having the range of uncertainty can take into a predetermined number of demand values. Then, the optimization unit 13 obtains optimum solutions for the discretized demand values. As described above, by providing the information processing apparatus 10 according to this example embodiment with the discretization unit 12 and the optimization unit 13, it is possible to calculate an optimum solution for the formulated robust optimization problem.

Further, in this example embodiment, constraints of Expressions (17) to (19) are set, and the optimization unit 13 calculates an optimum solution of the optimization model. Expressions (17) to (19) are the constraints that correspond to a case in which a production plan is most changed. That is, since the optimization unit 13 calculates an optimum production plan even when a production plan is most changed, it can be considered that the optimization unit 13 calculates an optimum production plan that satisfies the constraints for all the demand scenarios. Therefore, according to this example embodiment, the optimization unit 13 can approximately obtain an optimum solution of the optimization model even when a discretization is performed by the discretization unit 12.

Further, the optimization unit 13 can calculate an optimum solution for the amount of demand between the discretized values by using the optimum solutions for the upper and the lower limit values for the amount of demand between the discretized values. Thus, regardless of the predicted values input to the input unit 11, the output unit 14 can calculate an optimum production plan. Therefore, the information processing apparatus 10 according to this example embodiment can determine a production plan that satisfies the amounts of demand at all the times. That is, with the information processing apparatus 10 according to this example embodiment, it is possible to determine an optimum production plan while taking a constraint having a temporal continuity into consideration.

### Other Example Embodiments

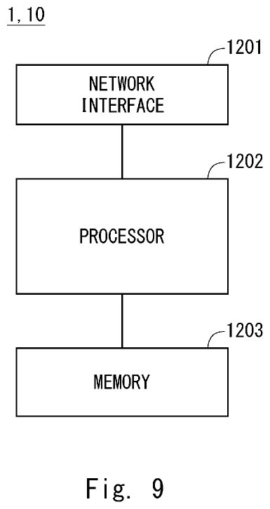

The information processing apparatuses according to the above-described example embodiments may have the following hardware configuration. FIG. 9 is a block diagram showing a configuration example of the information processing apparatuses 1 and 10 (hereinafter collectively referred to as the information processing apparatus 1 and the like) described in the above-described example embodiments. Referring to FIG. 9, the information processing apparatus 1 and the like each include a processor 1201 and a memory 1202.

The processor 1201 loads software (computer programs) from the memory 1202 and executes the loaded software, thereby performing the processing of the information processing apparatus 1 and the like described with reference to the flowcharts in the above-described example embodiments. The processor 1201 may be, for example, a microprocessor, a Micro Processing Unit (MPU), or a Central Processing Unit (CPU). The processor 1201 may include a plurality of processors.

The memory 1202 is composed of a combination of a volatile memory and a non-volatile memory. The memory 1202 may include a storage located apart from the processor 1201. In this case, the processor 1201 may access the memory 1202 via an Input/Output (I/O) interface (not shown).

In the example shown in FIG. 9, the memory 1202 is used to store software modules. The processor 1201 can load these software modules from the memory 1202 and execute the loaded software modules, thereby performing the processing of the information processing apparatus 1 and the like described in the above-described example embodiments.

As described with reference to FIG. 9, each of the processors included in the information processing apparatus 1 and the like executes one or a plurality of programs including instructions to cause a computer to perform an algorithm described with reference to the drawings.

In the above-described examples, the program(s) can be stored and provided to a computer using any type of non-transitory computer readable media. Non-transitory computer readable media include any type of tangible storage media. Examples of non-transitory computer readable media include magnetic storage media (e.g., flexible disks, magnetic tapes, and hard disk drives), optical magnetic storage media (e.g., magneto-optical disks). Further, examples of non-transitory computer readable media include CD-ROM (Read Only Memory), CD-R, and CD-R/W. Further, examples of non-transitory computer readable media include semiconductor memories. The semiconductor memories include, for example, mask ROM, PROM (Programmable ROM), EPROM (Erasable PROM), flash ROM, RAM (Random Access Memory), etc. Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described example embodiments and may be modified as appropriate without departing from the spirit of the present disclosure. Further, the present disclosure may be implemented by combining the example embodiments as appropriate.

The whole or part of the example embodiments disclosed above can be described as, but not limited to, the following supplementary notes.

(Supplementary Note 1)

An information processing apparatus comprising:

input means for inputting a predicted value of an amount of demand at each of a plurality of times; and

output means for outputting a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

(Supplementary note 2)

The information processing apparatus described in Supplementary note 1, wherein

the input means further inputs a first actual value indicating an actual value of the amount of demand and a second actual value indicating an actual value of the amount of production of each of the at least one production facility, and

the information processing apparatus further comprises:
discretization means for discretizing, into a predetermined number of demand values, values of the amount of demand that can be taken at each of the times determined based on the first actual value; and
optimization means for calculating, using the second actual value, the optimum solution at each of the times up to the predetermined time for the discretized demand value at each of the times up to the predetermined time.

(Supplementary Note 3)

The information processing apparatus described in Supplementary note 2, wherein at a second time before a first time, the discretization means divides the data range set in the amount of demand into a predetermined number of data ranges, sets a data range at the first time for each of the divided data ranges, and repeatedly executes, until the predetermined time, discretization processing for discretizing the values of the amount of demand that can be taken in the set data ranges into an upper limit value and a lower limit value of each of the set data ranges.

(Supplementary Note 4)

The information processing apparatus described in Supplementary note 3, wherein at each of the times, the output means specifies a data range to which the predicted value belongs, and determines the production plan that satisfies the predicted value based on a ratio of a distance between the predicted value and an upper limit value of the specified data range to a distance between the predicted value and a lower limit value of the specified data range, and optimum solutions for the upper and the lower limit values of the specified data range.

(Supplementary Note 5)

The information processing apparatus described in Supplementary note 3 or 4, wherein the optimization means calculates an optimum solution in which the planned value of each of the at least one production facility satisfies a predetermined condition at all the consecutive times up to the predetermined time for the discretized demand value at each of the times up to the predetermined time.

(Supplementary Note 6)

The information processing apparatus described in Supplementary note 5, wherein the optimization means:

calculates a planned value of each of the at least one production facility in which at each of the times up to the predetermined time, for each of the divided data ranges, a sum of the planned values of all the production facilities coincides with an upper limit value of the data range, the planned value of each of the at least one production facility being included between a first planned value and a second planned value determined from the planned value of each of the at least one production facility for an upper limit value and a lower limit value of a first data range indicating a data range from which the data range is set, as an optimum solution for the upper limit value; and

calculates a planned value of each of the at least one production facility in which the sum of the planned values of all the production facilities coincides with the lower limit value of the data range and which is included between the first planned value and the second planned value, the planned value of each of the at least one production facility coinciding with the optimum solution for an upper limit value of another data range having the same first data range as the data range and using the lower limit value of the data range as the upper limit value, as an optimum solution for the lower limit value.

(Supplementary Note 7)

The information processing apparatus described in Supplementary note 6, wherein

the first planned value is a larger one of a minimum value within the range of the constraint given to the planned value for the upper limit value of the first data range and a minimum value within the range of the constraint given to the planned value for the lower limit value of the first data range, and

the second planned value is a smaller one of a maximum value within the range of the constraint given to the planned value for the upper limit value of the first data range and a maximum value within the range of the constraint given to the planned value for the lower limit value of the first data range.

(Supplementary note 8)

The information processing apparatus described in any one of Supplementary notes 3 to 7, wherein

the discretization means regards the data range of each of the times as a node and generates relation information between the nodes, and

the output means specifies a node including the predicted value based on the generated relation information and determines a data range corresponding to the specified node to be the specified data range.

(Supplementary Note 9)

The information processing apparatus described in any one of Supplementary notes 1 to 8, wherein the data range is set based on a predictor determined in accordance with a prediction model of the amount of demand.

(Supplementary Note 10)

A production plan determination method comprising:

inputting a predicted value of an amount of demand at each of a plurality of times; and

outputting a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

(Supplementary Note 11)

A non-transitory computer readable medium storing a program for causing a computer to:

input a predicted value of an amount of demand at each of a plurality of times; and

output a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

### REFERENCE SIGNS LIST

1, 10 INFORMATION PROCESSING APPARATUS
2, 11 INPUT UNIT
3, 14 OUTPUT UNIT
12 DISCRETIZATION UNIT
13 OPTIMIZATION UNIT

What is claimed is:

1. An information processing apparatus comprising:
at least one memory storing instructions; and
at least one processor configured to execute the instructions to:
input a predicted value of an amount of demand at each of a plurality of times; and
output a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

2. The information processing apparatus according to claim 1,
wherein the at least one processor is configured to execute the instructions to:
input a first actual value indicating an actual value of the amount of demand and a second actual value indicating an actual value of the amount of production of each of the at least one production facility;
discretize, into a predetermined number of demand values, values of the amount of demand that can be taken at each of the times determined based on the first actual value; and
calculate, using the second actual value, the optimum solution at each of the times up to the predetermined time for the discretized demand value at each of the times up to the predetermined time.

3. The information processing apparatus according to claim 2,
wherein the at least one processor is configured to execute the instructions to:
divide at a second time before a first time, the data range set in the amount of demand into a predetermined number of data ranges;
set a data range at the first time for each of the divided data ranges; and
repeatedly execute, until the predetermined time, discretization processing for discretizing the values of the amount of demand that can be taken in the set data ranges into an upper limit value and a lower limit value of each of the set data ranges.

4. The information processing apparatus according to claim 3,
wherein the at least one processor is configured to execute the instructions to:
specify, at each of the times, a data range to which the predicted value belongs; and
determine the production plan that satisfies the predicted value based on a ratio of a distance between the predicted value and an upper limit value of the specified data range to a distance between the predicted value and a lower limit value of the specified data range, and optimum solutions for the upper and the lower limit values of the specified data range.

5. The information processing apparatus according to claim 3,
wherein the at least one processor is configured to execute the instructions to calculate an optimum solution in which the planned value of each of the at least one production facility satisfies a predetermined condition at all the consecutive times up to the predetermined time for the discretized demand value at each of the times up to the predetermined time.

6. The information processing apparatus according to claim 5,
wherein the at least one processor is configured to execute the instructions to:
calculate a planned value of each of the at least one production facility in which at each of the times up to the predetermined time, for each of the divided data ranges, a sum of the planned values of all the production facilities coincides with an upper limit value of the data range, the planned value of each of the at least one production facility being included between a first planned value and a second planned value determined from the planned value of each of the at least one production facility for an upper limit value and a lower limit value of a first data range indicating a data range from which the data range is set, as an optimum solution for the upper limit value; and
calculate a planned value of each of the at least one production facility in which the sum of the planned values of all the production facilities coincides with the lower limit value of the data range and which is included between the first planned value and the second planned value, the planned value of each of the at least one production facility coinciding with the optimum solution for an upper limit value of another data range having the same first data range as the data range and using the lower limit value of the data range as the upper limit value, as an optimum solution for the lower limit value.

7. The information processing apparatus according to claim 6, wherein
the first planned value is a larger one of a minimum value within the range of the constraint given to the planned value for the upper limit value of the first data range and a minimum value within the range of the constraint given to the planned value for the lower limit value of the first data range, and
the second planned value is a smaller one of a maximum value within the range of the constraint given to the planned value for the upper limit value of the first data range and a maximum value within the range of the constraint given to the planned value for the lower limit value of the first data range.

8. The information processing apparatus according to claim 3,
wherein the at least one processor is configured to execute the instructions to:
regard the data range of each of the times as a node and generates relation information between the nodes;
specify a node including the predicted value based on the generated relation information; and
determine a data range corresponding to the specified node to be the specified data range.

9. The information processing apparatus according to claim 1, wherein the data range is set based on a predictor determined in accordance with a prediction model of the amount of demand.

10. A production plan determination method comprising:
inputting a predicted value of an amount of demand at each of a plurality of times; and
outputting a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.

11. A non-transitory computer readable medium storing a program for causing a computer to:
input a predicted value of an amount of demand at each of a plurality of times; and
output a production plan that satisfies the predicted value based on an optimum solution of an optimization model in which at consecutive times, a constraint is given to an amount of production of each of at least one production facility and a data range indicating a range of uncertainty is set in the amount of demand, the optimization model determining the production plan including a planned value of the amount of production of each of the at least one production facility at each of the times up to a predetermined time for the amount of demand at each of the times up to the predetermined time.
